(19) United States
(12) Patent Application Publication
(10) Pub. No.: US 2003/0230969 A1
(43) Pub. Date: Dec. 18, 2003

(54) Glass spacer for electron beam excitation display

(76) Inventors: Toshiaki Mizuno, Osaka (JP); Akihiro Koyama, Osaka (JP); Kosuke Fujiwara, Osaka (JP); Isamu Kuroda, Osaka (JP); Yukihito Nagashima, Osaka (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/460,648

(22) Filed: Jun. 13, 2003

(30) Foreign Application Priority Data
Jun. 13, 2002 (JP) P2002-172642
Jun. 19, 2002 (JP) P2002-178114

(51) Int. Cl. H01J 1/62; H01J 63/04

(52) U.S. Cl. 313/495; 313/292

(57) ABSTRACT

A flat electron beam excitation display includes: a front panel 1 made of a glass substrate 15 having an image-forming member 5 formed in its inner surface; and a rear panel 2 made of a glass substrate 21 mounted with a group of electron emission devices. A plurality of glass spacers 4 are inserted between the front panel 1 and the rear panel 2 so that the glass spacers 4 serve as atmospheric pressure bearing members. Each of the glass spacers 4 is made of a glass composition containing 30% by mole to 80% by mole of SiO₂, 15% by mole to 40% by mole of transition metal oxide, 10% by mole to 50% by mole of RO (in which R is an alkaline-earth metal), and less than 5% by mole of R′₂0 (in which R′ is an alkali metal)

The present application is based on Japanese Patent Application No. 2002-172642 and No. 2002-178114, the entire contents of which are incorporated herein by reference.

### BACKGROUND OF THE INVENTION

1. Field of the Invention

The present invention relates to a glass spacer for electron beam excitation display and particularly to a glass spacer for electron beam excitation display, which has electron conducting characteristic so that the glass spacer can be effectively prevented from being electrically charged.

2. Related Art

A self-luminous type electron beam excitation display represented by an FED (field emission display) has attracted attention as a flat display which is thin and lightweight compared with a cathode-ray tube large and heavy and which is bright in obtained image and wide in viewing angle compared with a liquid crystal display device. The study of the self-luminous type electron beam excitation display has been advancing actively in recent years.

A flat electron beam excitation display includes: a front panel made of a glass substrate having an image-forming member formed in its inner surface; and a rear panel made of a glass substrate mounted with a group of electron beam emission devices (cathodes). The image-forming member has fluorescent substances which can form an image when irradiated with electron beams emitted from the electron emission devices. The front panel and the rear panel are bonded to each other airtightly through a support frame, so that the front and rear panels and the support frame form a vacuum container as an airtight structure resistant to atmospheric pressure (for example, JP-A-7-230776).

In the flat electron beam excitation display, the inside of the vacuum container in which constituent parts such as electron beam sources and fluorescent substances are built is kept in a vacuum atmosphere of not higher than about 1.33×10⁻⁸Pa (about 10⁻¹⁰ Torr) because an image is formed by irradiation of the fluorescent substances with electron beams. Accordingly, as the display screen of the display becomes large, the front panel and the rear panel are deformed or brought into contact with each other because of the atmospheric pressure difference between the inside of the vacuum container and the outside to make it impossible to display an image. To prevent the deformation or contact to keep the distance between the front panel and the rear panel constant, glass or ceramic spacers as atmospheric pressure bearing members are inserted between the front panel and the rear panel.

General glass or ceramic is however regarded as a non-conductor. Accordingly, when part of electrons emitted from an electron beam source collide with a spacer, the part of electrons are caught in the spacer to electrify the spacer. As this operation is repeated, the quantity of electrification of the spacer increases. When the quantity of electrification of the spacer exceeds an allowable value, electrons caught in the spacer are released at a stroke to generate an excessive electric current. As a result, there arises a problem that a display image is disordered.

As a method for solving the problem, there have been heretofore known a method in which an electron conducting film is formed on a surface of each spacer (for example, JP-A-8-180821), a method in which a ceramic material obtained by sintering a raw material mixed with an electron conducting substance is used as each spacer (for example, U.S. Pat. No. 5,675,212), etc. From the point of view of manufacturability, production cost, quality, etc., these methods are not fundamental solutions.

### SUMMARY OF THE INVENTION

An object of the invention is to provide a glass spacer for electron beam excitation display, which has such electron conducting characteristic that the glass spacer can be prevented from being electrically charged.

To achieve the foregoing object, the glass spacer according to the invention is a glass spacer used in an electron beam excitation display having glass substrates, the glass spacer being made of a glass composition containing 30% by mole to 80% by mole of SiO₂, 10% by mole to 40% by mole of transition metal oxide, 10% by mole to 50% by mole of RO (in which R is an alkaline-earth metal), and less than 5% by mole of R′₂O (in which R′ is an alkali metal).

Preferably, in the glass spacer accordingto the invention, the transition metal oxide is in a range of from 12% by mole to 30% by mole.

Preferably, inthe glass spacer according to the invention, the transition metal oxide is metal oxide containing at least one member selected from the group consisting of Fe, V, Ti, Co, Ni, Cu, Mn and Cr.

Preferably, in the glass spacer according to the invention, the R′₂O is 2.5% by mole or less.

Preferably, in the glass spacer according to the invention, the difference in linear heat expansion coefficient between each of the glass substrates and the glass spacer is not larger than 15%. Incidentally, the term “linear expansion coefficient” used in the invention means an average linear expansion coefficient in a temperature range of from 30° C. to 400° C.

### BRIEF DESCRIPTION OF THE DRAWINGS

FIG. 1 is an exploded perspective view of a flat electron beam excitation display having glass spacers for electron beam excitation display according to an embodiment of the invention;

FIG. 2 is a sectional view taken along the line II-II in FIG. 1;

FIG. 3 is a view showing schematic configuration of an apparatus for producing a glass spacer for electron beam excitation display according to an embodiment of the invention; and

FIG. 4 is a sectional view taken along the line VI-VI in FIG. 3.

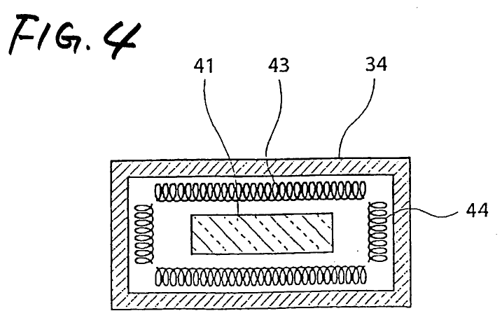

### DETAILED DESCRIPTION OF THE PREFERRED EMBODIMENTS

The inventors have made eager investigation to achieve the foregoing object. As a result, it has been found that a glass spacer, which is made of a glass composition containing 30% by mole to 80% by mole of SiO₂, 10% by mole to 40% by mole of transition metal oxide, 10% by mole to 50% by mole of RO (in which R is an alkaline-earth metal), and less than 5% by mole of R′₂O (in which R′ is an alkali metal), can be prevented from being electrically charged with electrons colliding with the spacer when the spacer is irradiated with an electron beam from an electron beam source.

The invention is based on the result of the investigation.

The configuration of a glass spacer for electron beam excitation display according to an embodiment of the invention will be described below with reference to the drawings.

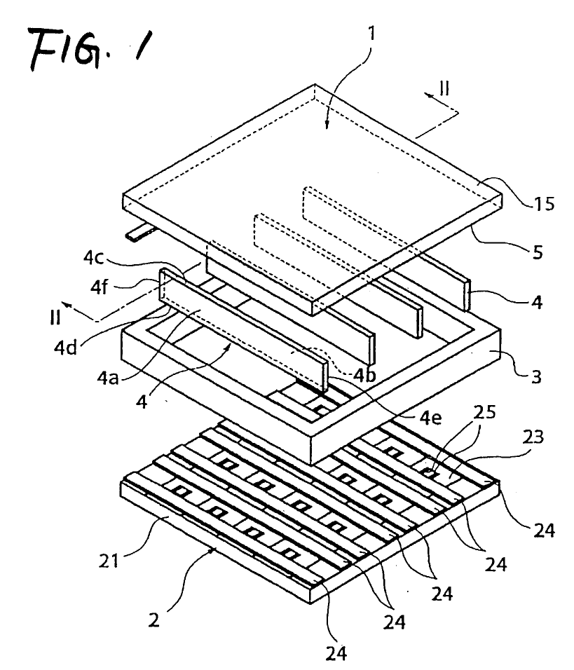

FIG. 1 is an exploded perspective view of a flat electron beam excitation display having glass spacers according to an embodiment of the invention.

In FIG. 1, the flat electron beam excitation display includes a front panel 1, and a rear panel 2. The front panel 1 is made of a glass substrate 15 having an image-forming member 5 formed in its inner surface. The rear panel 2 is made of a glass substrate 21 mounted with a group of electron beam emission devices. The image-forming member 5 has fluorescent substances which emit light when irradiated with electron beams emitted from the electron emission devices.

For example, each of the glass substrates 15 and 21 is made of soda lime glass, PDP high distortion spot glass or TFT aluminoborosilicate glass. The linear expansion coefficient of the glass is approximately in a range of from 35×10⁻⁷/° C. to 95×10⁻⁷/° C.

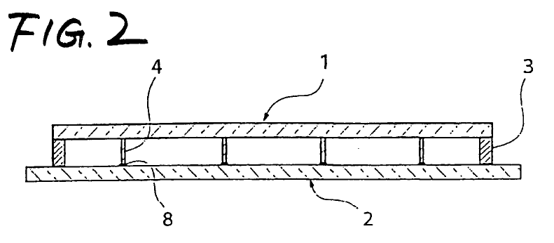

As shown in FIG. 2 which is a sectional view taken along the line II-II in FIG. 1, the front panel 1 and the rear panel 2 are bonded to each other airtightly through a support frame 3, so that the front and rear panels 1 and 2 and the support frame 3 form a vacuum container as an airtight structure resistant to atmospheric pressure. Further, a plurality of glass spacers 4 as atmospheric pressure bearing members are inserted between the front panel 1 and the rear panel 2.

The rear panel 2 includes a glass substrate 21, a plurality of device portions 23 arranged in the form of a matrix on the glass substrate 21, and a plurality of wiring portions 24 arranged on the glass substrate 21 to supply electric power to the plurality of device portions 23. Each of the device portions 23 is made of Ni about 100 nm thick. Each of the wiring portions 24 is made of Ag about 2 μm thick. Electron emission devices 25 are formed in the device portions 23 respectively. The wiring pattern of the wiring portions 24 is a pattern of parallel lines, so that a plurality of electron emission devices 25 arranged along each pair of adjacent wiring portions 24 can be supplied with electric power at once through the pair of adjacent wiring portions 24. Though not shown, a modulating electrode having electron-pass pores with a diameter of about 50 μm is further disposed at a distance of about 10 μm upward from the glass substrate 21 through an SiO₂ electrically insulating film.

A lower end of each of the glass spacers 4 is fixed to the rear panel 2 through an adhesive member 8. Alternatively, an upper end of each of the glass spacers 4 may be fixed to the front panel 1 through the adhesive member 8 or both upper and lower ends of each of the glass spacers 4 may be fixed to the front panel 1 and the rear panel 2 respectively through the adhesive member 8.

The aspect ratio (ratio of height/maximum width) of the sectional shape of each glass spacer 4 is generally in a range of from 4 to 50.

The thickness of each glass spacer 4 is preferably selected to be in a range of from 0.03 mm to 0.30 mm. Although it is preferable that each glass spacer 4 is as thin as possible because display based on light emission cannot be performed in a contact portion between the glass spacer 4 and each of the front and rear panels 1 and 2, it is difficult to handle the glass spacer 4 because of shortage of the absolute strength of the glass spacer 4 if the glass spacer 4 is thinner than 0.03 mm. In addition, the glass spacers 4 are disposed in the wiring portions 24 in order to improve the numerical aperture of the display. Generally, the width of each wiring portion 24 is not larger than 0.30 mm. Accordingly, it is not wise to select the thickness of the glass spacer 4 to be larger than the width of the wiring portion 24.

The height of each glass spacer 4 is selected to be generally in a range of from 0.7 mm to 5.0 mm, preferably in a range of from 1.0 mm to 3.0 mm. In the flat electron beam excitation display, a high acceleration voltage of from 5000 V to 6000 V is generally used in order to improve efficiency in use of the fluorescent substances. For this reason, if the distance between the front panel 1 and the rear panel 2 formed through the glass spacers 4 is smaller than 1.0 mm, it is difficult to keep the front and rear panels 1 and 2 electrically insulated from each other. If the distance is larger than 3.0 mm, an electron beam emitted from each electron beam source is spread so widely that adjacent pixels emit light undesirably.

The length of each glass spacer 4 is decided according to the size of the display and the method of production thereof. Generally, the length of each glass spacer 4 is selected to be in a range of from 30 mm to 2000 mm.

The display is assembled as follows. The glass spacers 4 are arranged at intervals of a predetermined pitch on the rear panel 2 mounted with a group of electron emission devices, through a sealing frit 8. Under this condition, the front panel 1 is bonded to the rear panel 2 and the glass spacers 4 by the sealing frit 8. Then, the resulting panel is heated at a temperature ranging from about 400° C. to about 500° C. to be sintered. In this manner, assembling of the display is completed.

The reason why the glass composition for forming the glass spacer for electron beam excitation display according to the invention is limited will be described below.

The glass composition for forming the glass spacer for electron beam excitation display according to the invention contains 30% by mole to 80% by mole of SiO₂, 10% by mole to 40% by mole of transition metal oxide, 10% by mole to 50% by mole of RO (in which R is an alkaline-earth metal), and less than 5% by mole of R′₂O (in which R′ is an alkali metal).

SiO₂ is a main component for forming the skeleton of glass. If the content of SiO₂ is smaller than 30% by mole, the durability of glass is too low to obtain stable glass. If the content of SiO₂ is larger than 80% by mole, the melting temperature of glass rises extremely to make it difficult to melt glass. Accordingly, the content of SiO₂ is selected to be in a range of from 30% by mole to 80% by mole, preferably in a range of from 40% by mole to 60% by mole.

Transition metal oxide is essential for giving electron conducting characteristic to glass. The content of transition metal oxide required for obtaining necessary electronic conductance is in a range of from 10% by mole to 40% by mole. If the content of transition metal oxide is smaller than 10% by mole, the function of the glass spacer for electron beam excitation display cannot be fulfilled because the electronic conductance of glass is too low to sufficiently release electric charge accumulated on the spacer. If the content of transition metal oxide is larger than 40% by mole, stable glass cannot be obtained because the glass is devitrified. Preferably, the content of transition metal oxide is selected to be in a range of from 12% by mole to 30% by mole.

Transition metal ions can exhibit two kinds of valences or three or more kinds of valences in glass. The valence of transition metal ions in glass varies according to the composition of glass and the condition at the time of production of glass. In the invention, the content of valences is important for giving required electronic conductance to glass. That is, in the case of transition metal ions having both bivalence and trivalence in glass, the content of bivalent transition metal ions is preferably in a range of from 10% to 90%. If the content of bivalent transition metal ions is smaller than 10% or larger than 90%, glass substantially has no electron conducting characteristic so that the function of the glass spacer for electron beam excitation display according to the invention cannot be fulfilled. In the case of transition metal ions exhibiting three or more kinds of valences in glass, the content of transition metal ions having each valence is preferably at least 10% for the same reason as described above.

The content of valences of transition metal oxide in glass can be controlled by various methods. When a glass raw material is melted in a general melting atmosphere, transition metal in glass is apt to be partial to a high valence side. However, when a glass raw material is melted in a reducing atmosphere, transition metal in glass can be kept in a low valence state. As the simplest method, carbon or the like is mixed with a glass raw material, and the mixture is then heated and melted in a reducing atmosphere.

Preferably, the transition metal is selected from the group consisting of Fe, V, Ti, Co, Ni, Cu, Mn and Cr. These metals differ in electron conducting characteristic because these metals differ in activation energy of respective elements for electron conducting characteristic. According to the inventors' examination, Fe, Cu and V are especially preferred because these metals exhibit moderate activation energy in glass.

RO, that is, alkaline-earth metal oxide such as MgO, CaO, SrO, and BaO is used for adjusting the devitrifying temperature and viscosity at the time of molding as well as improving the durability of glass. One kind of RO may be contained or two or more kinds of RO may be contained. If the total amount of RO is smaller than 10% by mole, the melting temperature rises so that the glass can hardly be melted and the durability of glass is reduced. If the total amount of RO is larger than 50% by mole, the devitrifying temperature rises. Preferably, the total amount of RO is in a range of from 20% by mole to 40% by mole.

If movable ions such as sodium ions are contained in glass for forming the glass spacer according to the invention, the ions move in glass according to a bias voltage. Consequently, the ions are unevenly distributed in glass, so that there arises a problem that electric field destruction occurs. Although it is therefore preferable from the point of view of prevention of this disadvantage that R′₂O, that is, alkali metal oxide such as Li₂O, Na₂O, and K₂O is not contained in glass if possible, less than 5% by mole of R′₂O may be contained in order to improve the acceleration of melting glass and to reduce the devitrifying temperature. The amount of R′₂O is selected to be preferably not larger than 2.5% by mole, more preferably not larger than 1% by mole. It is also preferable from the point of view of avoiding conducting characteristic of ions that alkali metal oxide contained is heavy element oxide if possible.

When the linear expansion coefficient of the glass spacer is different from that of the front or rear panel made of a glass substrate, one larger in linear expansion coefficient expands more greatly than the other smaller in linear expansion coefficient at temperature rise for sintering but one larger in linear expansion coefficient contracts more greatly than the other smaller in linear expansion coefficient at temperature fall. If the difference in linear expansion coefficient exceeds an allowable value, there is a possibility that the glass spacer may be warped, deformed, destroyed, etc. In the invention, therefore, the difference in linear expansion coefficient between the glass substrate and the glass spacer is selected to be preferably not larger than 15%, more preferably not larger than 10%. When the difference is in this range, the problem in warp, deformation, destruction, etc. of the glass spacer caused by the heat expansion coefficient difference at the time of heating can be prevented surely.

A desired value of the linear expansion coefficient of the glass spacer can be obtained by adjusting the composition of glass (especially by adjusting the content of alkali metal oxide) of the glass spacer. By suitably adjusting the linear expansion coefficient of the glass spacer in accordance with the glass substrate having the predetermined linear expansion coefficient, the difference in linear expansion coefficient between the glass substrate and the glass spacer in the product can be obtained within a predetermined range.

Incidentally, if the electric resistance of the glass spacer is too low, the glass spacer cannot be used because electrical short-circuiting occurs in the system viewed from the structure of the electron beam excitation display. On the other hand, if the electric resistance of the glass spacer is too high, accumulated electric charge cannot be relaxed sufficiently. Therefore, the resistivity of the spacer for electron beam excitation display according to the invention is preferably selected to be approximately in a range of from 10³ Ω·cm to 10¹⁰ Ω·cm.

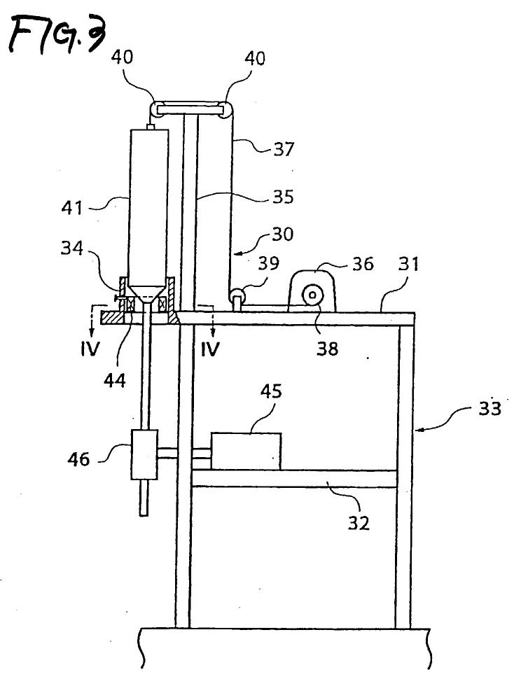

The method for producing the glass spacer for electron beam excitation display according to the invention is not particularly limited. Preferably, an apparatus for producing a glass spacer for electron beam excitation display as shown in FIG. 3 is used for producing the glass spacer by the following method.

First Step:

First, glass 41, which is a base material having a predetermined sectional shape, is prepared by applying mechanical processing such as cutting, shaving, or polishing to a glass material or by applying stretching such as welding, hot pressing, or hot extrusion to a glass material. The mother glass 41 is formed so that the sectional shape of the mother glass 41 is substantially similar to the sectional shape of a glass spacer 4 which will be obtained. The sectional area of the mother glass 41 is substantially in a range of from 100 times to 700 times as large as the sectional area of a glass spacer 4 which will be obtained.

Second Step:

The prepared mother glass 41 is attached to an end of a wire 37 in the producing apparatus 30 so as to be hung down. A drive shaft of a motor 36 is rotated so that a lower end portion of the mother glass 41 is introduced into a heating furnace 34. Then, electric heaters 43 and 44 are switched on so that the lower end portion of the mother glass 41 is heated in the heating furnace 34. Stretched glass hung down from the mother glass 41 by this heating is made to pass through a stretching roll 46 and pulled down with the stretching roll 46 rotated by a motor 45.

Then, the motors 36 and 45 are respectively controlled so that the stretched glass is pulled down at a predetermined stretching rate which will be described later while the mother glass 41 is introduced into the heating furnace 34 at a predetermined supply rate which will be described later. On this occasion, the electric heaters 43 and 44 are controlled so that the temperature for heating the mother glass 41 is in a predetermined range. That is, the mother glass 41 is heated in such a predetermined temperature range that the viscosity of the mother glass 41 is in a range of from 10⁴ Pa.s to 10⁸ Pa.s (from 10⁵ poise to 10⁹ poise), preferably in a range of from 10⁷ Pa.s to 10⁵ Pa.s (from 10⁸ poise to 10⁹ poise).

The ratio of the stretching rate of the mother glass 41 to the supply rate of the mother glass 41 is preferably in a range of from 20 to 8000. If the ratio is lower than 20, the elongation percentage of the mother glass 41 is so small that productivity is worsened. If the ratio is higher than 8000, the elongation percentage is so large that the sectional shape of the stretched glass perpendicular to the stretching direction becomes unstable. More preferably, the ratio is in a range of from 100 to 7000.

Third Step:

Then, the stretched glass is cut into glass spacers 4 each having a predetermined length. The cutting can be performed by a diamond saw, a glass cutter, a water jet machine or the like. Because four surfaces other than the cut surfaces of each glass spacer 4 are substantially formed as fire-polished surfaces at the time of heating and stretching, accuracy of finishing of the original glass is not so significant. The term “fire-polished surfaces” means surfaces of glass in the case where molten glass is molded, for example, into a plate shape while the heating temperature is controlled on the basis of the correlation between the viscosity of glass and the heating temperature in the condition that the molten glass is not brought into contact with a molding tool or the like. Such fire-polished surfaces are characterized by flatness microscopically because small bumps on the molding tool are not transferred onto the fire-polished surfaces.

By the three steps, glass spacers 4 each having a required sectional shape substantially similar to the sectional shape of the mother glass 41 can be formed from the mother glass 41.

### EXAMPLES

The invention will be described below more specifically on the basis of Examples and Comparative Examples.

Each mother glass 41 was prepared as follows. Optical glass silica sand as an SiO₂ material, necessary transition metal oxide as a transition metal oxide material, metal carbonate as an RO (in which R is an alkaline-earth metal) material and metal carbonate as an R′₂O (in which R′ is an alkali metal) material were mixed in a predetermined proportion so that the weight of glass after melting was 300 g. The raw material mixture was put in a platinum crucible and melted for 2 hours in an electric furnace kept at a temperature ranging from 1500° C. to 1550° C. After melted, the glass was poured onto an iron plate and molded to obtain a thickness of about 5 mm. On this occasion, the vitreous state was judged on the basis of observation of presence/absence of devitrified glass so that the case where no devitrified glass was produced was evaluated as ◯ and the case where devitrified glass was produced was evaluated as X. Table 1 shows results of the judgment. Incidentally, in Table 1, the numerical value given to each glass component shows % by mole.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| SiO₂ | 50.0 | 59.7 | 38.0 | 30.0 | 65.0 | 50.0 | 35.0 | 33.0 |
| Fe₂O₃ | 20.0 | 20.0 | 20.0 | 30.0 | 15.0 | 15.0 | 16.0 | 36.0 |
| V₂O₅ | | | | | | | | |
| TiO₂ | | | | | | | | |
| NiO | | | | | | | | |
| CuO | | | | | | | | |
| MnO | | | | | | | | |
| CrO | | | | | | | | |
| SrO | 29.8 | 20.0 | 42.0 | 40.0 | 20.0 | 20.0 | 30.0 | 30.0 |
| BaO | | | | | | 15.0 | 10.0 | |
| MgO | | | | | | | 6.0 | |
| CaO | | | | | | | | |
| Li₂O | | | | | | | | |
| Na₂O | 0.2 | 0.3 | 0.0 | 0.0 | | | 1.0 | 0.5 |
| K₂O | | | | | | | 2.0 | 0.5 |
| Total | 100.0 | 100.0 | 100.0 | 100.0 | 100.0 | 100.0 | 100.0 | 100.0 |
| Vitrification | ◯ | ◯ | ◯ | ◯ | ◯ | ◯ | ◯ | ◯ |
| Electronic | | | | | | | | |
| conduction | ◯ | ◯ | ◯ | ◯ | ◯ | ◯ | ◯ | ◯ |

| | Example | Example | Example | Example | Example | Example | Example |
|---|---|---|---|---|---|---|---|
| | 9 | 10 | 11 | 12 | 13 | 14 | 15 |
| SiO₂ | 45.0 | 44.0 | 40.0 | 44.0 | 60.0 | 50.0 | 45.0 |
| Fe₂O₃ | 36.0 | | | | | | |
| V₂O₅ | | 20.0 | | | | 5.0 | |
| TiO₂ | | 5.0 | 20.0 | 5.0 | | | |
| NiO | | | | 20.0 | | | |
| CuO | | | | | 20.0 | | |
| MnO | | | | | | 27.0 | |
| CrO | | | | | | | 20.0 |
| SrO | 15.0 | 25.0 | 20.0 | 25.0 | 18.0 | 6.0 | 15.0 |
| BaO | 4.0 | 5.0 | 10.0 | 5.0 | 2.0 | 4.0 | 10.0 |
| MgO | | | 5.0 | | | 3.0 | 5.0 |
| CaO | | | 5.0 | | | 3.0 | 5.0 |
| Li₂O | | | | | | | |
| Na₂O | | 0.5 | | 0.5 | | 1.0 | |
| K₂O | | 0.5 | | 0.5 | | 1.0 | |
| Total | 100.0 | 100.0 | 100.0 | 100.0 | 100.0 | 100.0 | 100.0 |
| Vitrification | ◯ | ◯ | ◯ | ◯ | ◯ | ◯ | ◯ |
| Electronic | ◯ | ◯ | ◯ | ◯ | ◯ | ◯ | ◯ |
| conduction | | | | | | | |

After molded, the glass was kept hot for one hour in the condition that the glass was put in an electric furnace heated to a temperature ranging from 500° C. to 600° C. in advance. Then, a power supply of the electric furnace was switched off so that the glass was cooled naturally. After the glass was polished to a thickness of about 3 mm, the electric resistance of the glass was measured. Specifically, the measurement procedure was performed according to JIS-R214. As already reported (e.g., J. D. Mackenzie, Modern Aspects of the Vitreous States, Vol.3), the electron conducting characteristic of glass can be judged on the basis of change in electric resistance with time. That is, when a DC current is continuously passed through general glass exhibiting ion conducting characteristic, ions are unevenly distributed so that the resistance of the glass increases with the passage of time. In glass exhibiting electron conducting characteristic, such change in resistance is not observed, that is, the resistance of the glass does not change even in the case where a DC current is continuously passed through the glass. The electron conducting characteristic obtained in the invention was judged on the basis of comparison between the value measured just after the current begun to be passed through the glass and the value measured after the current had been passed through the glass for 3 hours. In Table 1, the electron conducting characteristic was judged as follows. That is, the case where the resistance of the glass did not change so that the glass exhibited electron conducting characteristic was evaluated as ◯ and the case where the resistance of the glass changed so that the glass did not exhibit electron conducting characteristic was evaluated as X. As is obvious from Table 1, in the scope of the invention, electron conducting glass excellent in stability can be provided, so that a glass spacer adapted to an electron beam excitation display can be provided.

Table 2 shows glass as Comparative Examples. In Table 2, the numerical value in each glass component shows % by mole. The evaluation as to the presence/absence of devitrified glass and the presence/absence of electron conducting characteristic is the same as in Examples.

TABLE 2

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| SiO₂ | 72.4 | 58.2 | 25.0 | 40.0 | 50.0 | 60.0 | 44.0 |
| Al₂O₃ | 1.4 | 6.8 | | | 1.0 | | |
| Fe₂O₃ | 0.1 | 0.1 | 30.0 | 8.0 | | 30.0 | 20.0 |
| V₂O₅ | | | | | | | 10.0 |
| ZrO₂ | | 2.7 | | | | | |
| TiO₂ | | | | | | | |
| NiO | | | | | | | |
| CuO | | | | | 9.0 | | |
| MnO | | | | | | | |
| CrO | | | | | | | |
| SrO | | 6.8 | 30.0 | 30.0 | 7.0 | 2.0 | 6.0 |
| BaO | | 7.8 | 10.0 | 10.0 | 8.0 | 5.0 | 2.0 |
| MgO | 4.1 | 2.1 | | 5.0 | 10.0 | 2.0 | 4.0 |
| CaO | 8.1 | 4.8 | | 5.0 | 10.0 | | 6.0 |
| Li₂O | | | | | | | |
| Na₂O | 13.2 | 4.1 | 3.0 | 1.0 | 3.0 | 0.5 | 4.0 |
| K₂O | 0.7 | 6.6 | 2.0 | 1.0 | 2.0 | 0.5 | 4.0 |
| Total | 100.0 | 100.0 | 100.0 | 100.0 | 100.0 | 100.0 | 100.0 |
| Vitritication | ◯ | ◯ | X | ◯ | ◯ | X | X |
| Electronic | X | X | ◯ | X | X | ◯ | ◯ |
| conduction | | | | | | | |

In Table 2, Comparative Examples 1 and 2 show typical examples of glass available on the market. In each of Comparative Examples 1 and 2, very stable glass was obtained but the glass did not exhibit electron conducting characteristic. In an electron beam excitation display using glass spacers produced from the glass byway of trial, the electrically charged state was observed everywhere.

In Comparative Example 3, the glass contained transition metal oxide sufficient to exhibit electron conducting characteristic but was not stable. Accordingly, a plurality of devitrified portions occurred at the time of production of glass, so that the glass could not be used for forming spacers.

In each of Comparative Examples 4 and 5, stable glass was obtained but the glass did not exhibit sufficient electron conducting characteristic because the amount of transition metal oxide contained in the glass was too small.

In Comparative Examples 6 and 7, there were shown glass containing a small amount of RO (in which R is an alkaline-earth metal) and glass containing a large amount of R′₂O (in which R′ is an alkali metal). In the former, it was difficult to obtain homogeneous glass as well as the melting temperature was high. In the latter, devitrification was high. The glass obtained in each of Comparative Examples 6 and 7 exhibited electron conducting characteristic but was neither stable nor homogeneous sufficiently to obtain spacers.

As described above in detail, the glass spacer according to the invention is made of a glass composition containing 30% by mole to 80% by mole of SiO₂, 10% by mole to 40% by mole of transition metal oxide, 10% by mole to 50% by mole of RO (in which R is an alkaline-earth metal), and less than 5% by mole of R′₂O (in which R′ is an alkali metal). Accordingly, the glass spacer has such electron conducting characteristic that the glass spacer can be effectively prevented from being electrically charged with electrons caught in the glass spacer when part of electrons emitted from an electron beam source collide with the glass spacer.

Preferably, in the glass spacer accordingly to the invention, the transition metal oxide is in a range of from 12% by mole to 30% by mole. Accordingly, the glass spacer can be obtained as a highly stable glass spacer having sufficient electron conducting characteristic so that the glass spacer can be prevented from being electrically charged.

Preferably, in the glass spacer according to the invention, the transition metal oxide is metal oxide containing at least one member selected from the group consisting of Fe, V, Ti, Co, Ni, Cu, Mn and Cr. Accordingly, the glass spacer can be obtained as a glass spacer exhibiting electron conducting characteristic in practical use.

Preferably, in the glass spacer according to the invention, the R′₂O is 2.5% by mole or less. Accordingly, the effect of preventing the glass spacer from being electrically charged can be obtained more surely.

Preferably, in the glass spacer according to the invention, the difference in linear heat expansion coefficient between each of the glass substrates and the glass spacer is not larger than 15%. Accordingly, the glass spacer can be prevented from being warped, deformed or destroyed when the glass spacer is heated.

What is claimed is:

1. A glass spacer used in an electron beam excitation display having glass substrates, wherein said glass spacer is made of a glass composition containing 30% by mole to 80% by mole of SiO₂, 10% by mole to 40% by mole of transition metal oxide, 10% by mole to 50% by mole of RO, and less than 5% by mole of R′₂O.
in which R is an alkaline-earth metal, and R′ is an alkali metal.

2. A glass spacer for electron beam excitation display according to claim 1, wherein said transition metal oxide is in a range of from 12% by mole to 30% by mole.

3. A glass spacer for electron beam excitation display according to claim 1, wherein said transition metal oxide is metal oxide containing at least one member selected from the group consisting of Fe, V, Ti, Co, Ni, Cu, Mn and Cr.

4. A glass spacer for electron beam excitation display according to claim 1, wherein said R′₂O is not larger than 2.5% by mole.

5. A glass spacer for electron beam excitation display according to claim 1, wherein difference in linear heat expansion coefficient between each of said glass substrates and said glass spacer is not larger than 15%.

6. A flat electron beam excitation display comprising:
a front panel made of a first glass substrate having an image-forming member formed in an inner surface thereof; and
a rear panel made of a second glass substrate on which a plurality of electron emission devices are mounted;
a plurality of glass spacers inserted between said front panel and said rear panel so that said front and rear panels are apart from each other at a predetermined distance;
wherein said glass spacer is made of a glass composition containing 30% by mole to 80% by mole of SiO₂, 10% by mole to 40% by mole of transition metal oxide, 10% by mole to 50% by mole of RO (in which), and less than 5% by mole of R′₂O,
in which R is an alkaline-earth metal, and R′ is an alkali metal.
